(19) United States
(12) Patent Application Publication
(10) Pub. No.: US 2009/0031486 A1
(43) Pub. Date: Feb. 5, 2009

(54) Articles Of Base Layer Apparel Including Zones Having Different Thermal Properties

(75) Inventors: Susan Sokolowski, Portland, OR (US); Dana Reinisch, Portland, OR (US)

Correspondence Address: BANNER & WITCOFF, LTD., 1100 13th STREET, N.W., SUITE 1200, WASHINGTON, DC, 20005-4051, US

(73) Assignee: Nike, Inc., Beaverton, OR (US)

(21) Appl. No.: 12/180,893

(22) Filed: Jul. 28, 2008

Related U.S. Application Data
(60) Provisional application No. 60/953,579, filed on Aug. 2, 2007.

(51) Int. Cl. A62B 17/00; A41D 1/00; A41D 27/02; A41D 31/00

(52) U.S. Cl. 2/458; 2/69; 2/272; 2/243.1

(57) ABSTRACT

Cold weather garments include one or more zones with increased thermally insulative and/or thermally resistive properties. Such garments reflect different gender needs. Such garments can allow wearers to maintain a necessary or desired degree of warmth with decreased garment weight and bulk. Methods of making such garments also are described.

This application claims priority to provisional application Ser. No. 60/953,579, filed Aug. 2, 2007, which is hereby incorporated by reference in its entirety.

### FIELD OF THE INVENTION

Aspects of the present invention generally relate to base layer garments that include one or more zones to maintain a degree of warmth.

### BACKGROUND

The human body may suffer adverse effects when exposed to cool or cold environmental conditions, particularly when exposed to such conditions for lengthy time periods. While people can simply add another layer of clothing to help stave off the adverse effects of a cold environment in some situations, this simple solution does not necessarily work well for athletes involved in practice or competition. For example, the addition of clothing layers can adversely impact the wearer's ability to freely move, particularly when engaged in exercise, athletic events, or other activities requiring movement. The additional weight, bulk, and/or wind resistance resulting from the additional clothing also can adversely impact athletic performance and expose the athlete to injury due to diminished flexibility, performance, and the like. The adverse impacts on performance and comfort may deter some users from adequately dressing to protect themselves from the cold. This attempted “work-around” action also can harm the wearer's health and well being. Moreover, clothes designed for warmth during physical activity do not account for the gender difference in a body's ability to generate and maintain heat.

### SUMMARY

Some example aspects of the present invention relate to garment structures containing thermal materials that provide a balance of thermal insulative and thermal resistive properties, air permeability, fabric stretch, structure, and garment construction. These and other advantageous properties may be realized, in accordance with examples of this invention, by providing a garment structure including targeted zones of thermal properties. Moreover, the targeted zones of garment take into account gender differences in the way a body regulates its skin temperature.

The garments are base layer garments which are garments intended to be worn directly against the skin to wick moisture during aerobic activity. The base layer garments may also have thermal properties to provide a desired consistent body skin temperature.

Garments in accordance with aspects of this invention designed for the upper body of a woman may include: a first garment region generally extending along the front and back of the upper body from proximate to a hip area of the garment to proximate to a neck area of the garment but generally excluding the forearms and hands; and a second garment region generally extending along the forearms, covering at least the area from the top of the forearm, from elbow to the wrist, and an optional third garment region generally extending over the hands; wherein the first garment region includes a first material, the second garment region includes a second material, and the third garment region includes a third material wherein each of the first, second, and third materials provide a consistent body skin temperature of about 22° C. to about 34° C. (about 71° F. to about 93° F.) when tested on a subject in an environmental chamber at temperatures between −1° C. to 10° C. (30° F. and 50° F.). In one embodiment, the second garment region wraps about 180 degrees around the forearm muscle.

Garments in accordance with aspects of this invention designed for the lower body of a woman may include: a first garment region generally extending along the front and back of the lower body, but generally excluding the quadriceps and buttocks and hamstrings; and a second garment region extending along the quadriceps, covering at least the front of the thigh from about 2 inches above the knee to the top of the leg, and wrapping, for example, about 180 degrees around the front thigh muscle, and from the top of the buttocks to the middle of the hamstring and, for example, about 100 degrees around the back of the leg, wherein the first garment region includes a first material and the second garment region includes a second material, wherein each of the first and second materials provide a consistent body skin temperature of 22° C. to about 34° C. when tested on a subject in an environmental chamber at temperatures between −1° C. to 10° C.

In addition, garments in accordance with aspects of this invention designed for the upper body of a man may include: a first garment region generally extending along the front and back of the upper body from proximate to the hip area of the garment to proximate to a neck area of the garment but generally excluding the forearms and hands; a second garment region generally extending along the forearms, covering at least the area from the top of the forearm, from elbow to the wrist; and a third optional garment region covering the hands; wherein the first garment region includes a first material, the second garment region includes a second material, and the third garment region includes a third material wherein each of the second and third materials provide a consistent body skin temperature of 22° C. to about 34° C. when tested on a subject in an environmental chamber at temperatures between −1° C. to 10° C. In one embodiment, the second garment region wraps about 180 degrees around the forearm muscle.

The following two paragraphs were added in view of your statement regarding the 2 zones—cold and very cold. Note that the lower body garment would be a single material. Garments in accordance with other aspects of this invention designed for the upper body of a woman or man may include: a first garment region generally extending along the front and back of the upper body from proximate to a hip area of the garment to proximate to a neck area of the garment but generally excluding the forearms and hands; and a second garment region generally extending along the forearms, covering at least the area from the top of the forearm, from elbow to the wrist, and generally extending over the hands; wherein the first garment region includes a first material and the second garment region includes a second material, wherein each of the first and second materials provide a consistent body skin temperature of about 22° C. to about 34° C. (about 71° F. to about 93° F.) when tested on a subject in an environmental chamber at temperatures between −1° C. to 10° C. (30° F. and 50° F.).

Garments in accordance with other aspects of this invention designed for the lower body of a woman or man may include a material that provides a consistent body skin temperature of 22° C. to about 34° C. when tested on a subject in an environmental chamber at temperatures between −1° C. to 10° C.

Additional aspects of this invention relate to methods of forming garments, e.g., of the various types described above. Such methods may include formation of garments as a single piece (e.g., by knitting or other garment forming processes) to include the various regions or formation of garments from multiple pieces joined together, e.g., in conventional ways, such as by sewing or stitching techniques, by adhesives or other fusing techniques, etc. The first, second, and third garment regions may be made from separate and independent pieces of fabric material (optionally the same type of fabric material) that are joined to a separate piece of fabric material embodying the fourth garment region (e.g., by sewing or other techniques). Alternatively, if desired, one or more of the various garment regions may be included as part of a single piece of material.

### BRIEF DESCRIPTION OF THE DRAWINGS

Various aspects, objects, features, and advantages of the present invention will be more readily apparent and more fully understood from the following detailed description, taken in conjunction with the appended drawings, in which:

FIGS. 1A and 1B illustrate front and back temperature zones in a body of a woman;

FIGS. 2A and 2B illustrate front and back temperature zones in a body of a man;

FIGS. 3A and 3B illustrate front and back, respectively, of a garment structure in accordance with an aspect of this invention, and FIG. 3C illustrates an optional internal finger sleeve;

FIGS. 4A and 4B illustrate front and back, respectively, of a garment structure in accordance with another aspect of this invention.

FIGS. 5A and 5B illustrate front and back, respectively, of a garment structure in accordance with an example of this invention, and FIG. 5C illustrates an optional internal finger sleeve;

FIGS. 6A and 6B illustrate front and back, respectively, of a garment structure in accordance with another aspect of this invention.

FIGS. 7A and 7B illustrate front and back, respectively of a garment structure in accordance with another aspect of this invention.

FIGS. 8A and 8B illustrate a sleeve garment structure in accordance with another aspect of this invention.

FIG. 9 illustrates a garment structure in accordance with another aspect of this invention.

The reader is advised that the attached drawings schematically illustrate various structures and features of garments in accordance with examples of this invention. These drawings are not production drawings, and they are not necessarily drawn to scale.

### DETAILED DESCRIPTION

Various specific examples of the invention are described in detail below in conjunction with the attached drawings. The following provides a general description of aspects and features of structures according to examples of the invention as a prelude to the more detailed description of specific structures that follows.

Aspects of the present invention are directed to strategically placing materials into engineered zones of apparel for improved thermal comfort of different regions of the body depending on whether the garment is for a man or for a woman.

The term “thermal resistance” or “thermal resistivity,” as used herein (also referred to as “RCT”) relates to the ability of a material to resist the transfer of heat by conduction, radiation, and convection. In terms of fabric materials or garments, these terms may be considered as relating to the amount of energy required to keep the air temperature constant between skin and fabric while the outside or environmental air temperature is cooler. Because heat flows from warm to cold, one way to control conduction of heat to the outside of a garment is by using an insulating material in the garment, and the insulating material's “thermal resistance” or “thermal resistivity” is a measure of the material's ability to withstand this transfer of heat. RCT is not predictable. More particularly, material weight and thickness are not predictors of RCT.

For fabrics, thermal resistance may be measured by an International Organization for Standardization Test ISO 11092 (entitled “Measurement of Thermal and Water-Vapour Resistance Under Steady-State Conditions” (e.g., measurable by the commercially available “Sweating Guarded Hotplate” system, available, for example, from Measurement Technology Northwest of Seattle, Wash.). This test method, which is publicly known, is incorporated herein by reference. In general, in this test method, a hotplate with in integral “sweating” surface in placed in a climatic chamber having a variable speed airflow hood, a gravity fed fluid supply system, and ambient temperature and humidity probes (to thereby duplicate or simulate human skin in real world conditions of temperature, relative humidity, and wind speed). Heat transfer across material samples can be measured using this system (e.g., the various parameters, such as temperature, humidity, and wind speed may be controlled (changed in a controlled manner or held constant) to enable relative comparison of fabrics. The test results by this system are expressed in units of “square meters×° Kelvin/Watts” (m×K/W).

It was discovered that gender differences exist in thermoregulation when maintaining medium to high aerobic activity (e.g. running) in cold temperatures, in particular temperatures from about −1° C. to about 10° C. (about 30° F. to about 50° F.). The most significant differences were found with skin temperatures of the upper body, forearm, hand and quadriceps, buttocks and hamstrings; where women maintained colder temperatures than men. In particular, women have different temperature zones than men. The zones can be characterized as follows:

| | |
|---|---|
| A | Comfort zone |
| B | Slightly cold zone |
| C | Cold zone |
| D | Very Cold Zone |

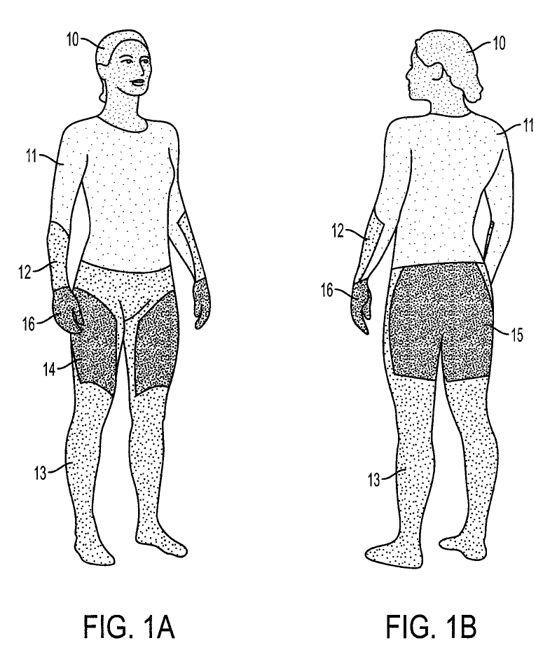

As shown in FIGS. 1A and 1B, woman's thermal zones are generally as follows in cold weather.

| | |
|---|---|
| A | Head and neck (10) |
| B | Upper body (11) including back, |
| | front, shoulders, and upper arms |
| C | Forearms (12) and legs (13) (except |
| | quadriceps and buttocks/hamstrings) |
| D | Quadriceps (14) buttocks/hamstrings |
| | (15), and hands (16). |

The forearm thermal zone (12) generally covers the area from the elbow joint to wrist and generally wraps about 180 degrees around forearm muscle.

The quadriceps thermal zone (14) generally covers the front of the thigh from about 2″ above the knee to the top of the leg—where it bends and generally wraps about 180 degrees around the muscles.

The buttock and hamstring thermal zone (15) generally covers the area from about 8″ above back of the knee to the bottom of the waistband and generally wraps about 100 degrees around the muscle.

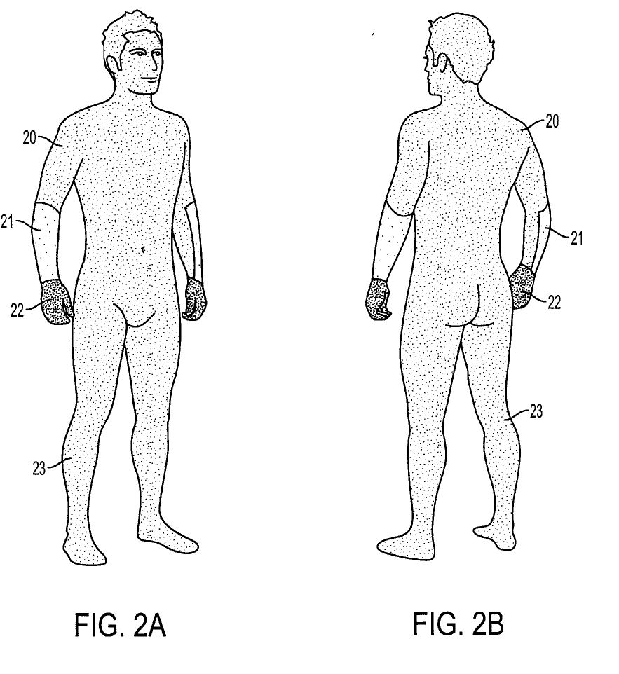

As shown in FIGS. 2A and 2B, man's thermal zones are generally as follows in cold weather.

| | |
|---|---|
| A | The upper body (20) except forearms |
| | and hands (20) and the lower body |
| | (23) |
| B | Forearms (21) |
| C | Hands (22) |
| D | n/a |

The forearm thermal zone (21) generally covers the area from the elbow joint to wrist and generally wraps about 180 degrees around the forearm muscle.

Men's mean skin temperature is generally warmer than women's for the upper body, forearm, hand, and quadriceps when running in cold temperature (5° C./41° F.). However, within males, the hand was the coldest region of the body when running in the cold.

Materials used in the various zones should reflect suitable materials to maintain a consistent body skin temperature of about 22° C. to about 34° C. for that zone whether male or female. Consistent being consistently within the temperature range identified. The desired skin temperature may depend on the type of activity, for example, the desired skin temperature for resting may be 29° C. to 34° C., for light exercise may be 25° C. to 33° C., and for heavy exercise: 22° C. to 32° C. Light exercise may be walking, for example, and heavy exercise may be running, for example.

For example, zone B base materials would provide greater warmth than zone A base materials. In general, fabrics selected for the comfort zone or slightly cold zones of the body meet an RCT value of about 0.013 to about 0.020 and fabrics selected for the cold/very cold zones meet an RCT value of about 0.029 to about 0.040.

However, it is not simply RCT of the thermal material that is important. In order to obtain the right type of thermal material to maintain the ideal temperature, RCT, air permeability, stretch, garment structure, and garment construction should be considered. It is a balance of these considerations that provides the right type of material to use in each of the zones. Air permeability refers to the rate of air flow passing perpendicularly through a known area under a prescribed air pressure differential between the two surfaces of a material. Air permeability of fabric at a stated pressure differential between two surfaces of the fabric is generally expressed in SI units as cm³/s/cm² and in inch-pound units as or ft³/min/ft² calculated at operating conditions.

For example, a base layer garment may have a RCT of 0.044 (which is very high for a base layer), but if it has a high air perm (over 100) the garment overheats the body and further, when the air flows through the fabric, a “gradient effect” is felt (where the body feels chilled and clammy). This does not provide the desired thermal result. Thus, both RCT and air permeability should be taken into account and balanced. Material construction is also important. For example, a sphere fabric construction may be able to trap heat better and be a better performer than a jersey construction. Another factor is considering the fabric is worn stretched on the human body which can affect RCT and air permeability. Stretch refers to the amount the fabric stretches when placed on the body. Typical fabrics for athletic use stretch between 5 and 20% with a stretch of about 15% being targeted. Base layer garments are typically worn tight.

It is desired to maintained consistent body skin temperature without overheating or promoting undue sweating during the period of aerobic activity such as running. Hence the fabrics used in the garment should have effective moisture management. For example, the fabrics should be able to wick moisture away from the body based on the DriFIT standard for wicking.

In the following description, thermal materials are used in zones of the body to provide a consistent body skin temperature of 22° C. to about 34° C. (about 71° F. to about 93° F.) when tested on a subject in an environmental chamber at temperatures between −1° C. to 10° C. (30° F. and 50° F.). The subject in the environmental chamber is generally running on a treadmill to simulate running in an outdoor environment. Thermisters are applied to the body at various sites such as typically the forehead, chest, abdomen, forearm, hand, thigh, scapula, and lumbar. The thermisters allow the temperature of the skin to be monitored and recorded.

The subject is typically a human subject. However, the subject may also be a device that simulates the human body such as a MANIKIN. Other suitable means may be used to measure the temperature of the body.

### I. GENERAL DESCRIPTION OF ASPECTS OF THE INVENTION

### A. Garments in Accordance with Example Aspects of this Invention

### 1) Women's Garments

The women's garment incorporates different materials to keep different regions of the body comfortable while running or doing other aerobic activity in cold temperatures between −1° C. to 10° C. (30° to 50° F.).

In general, at least some example aspects of this invention relate to garments (also called “articles of apparel” herein designed for women. A garment for a woman's upper body may include: (a) a first garment region generally extending along the front and back of the upper body, but generally excluding at least the top of the forearms and hands; (b) a second garment region generally extending along the forearms, covering an area on top of the forearm, from the elbow to the wrist, for example; and optionally (c) a third garment region generally extending from the sleeve to cover the hands. In one embodiment, the second garment region wraps about 180 degrees around the forearm muscle.

The first garment region in accordance with at least some aspects of this invention will include a first material; the second garment region will include a second material; and the third garment region will include a third material. Each of the first, second, and third materials provide a consistent body skin temperature of 22° C. to about 34° C. (about 71° F. to about 93° F.) when tested on a subject in an environmental chamber at temperatures between −1° C. to 10° C. (30° F. and 50° F.).

Garment structures in accordance with examples of this invention may take on a variety of forms or structures without departing from this invention. For example, the first garment region may also include part of neck region such as a mock turtleneck. The first garment region may also be prepared from two types of materials that each provides the desired body temperature. For example, less bulky materials may be used on the side portions of the upper body of the garment underneath the arms to provide efficient arm swing and more flattering seam lines.

A garment for a woman's lower body may include: (a) a first garment region generally extending along the front and back of the lower body, but generally excluding the quadriceps and buttocks and hamstrings; (b) a second garment region generally extending along the quadriceps, covering the front of the thigh from about 2 inches above the knee to the top of the leg (where it bends), and wrapping, for example, about 180 degrees around the front thigh muscle; and optionally (c) a third garment region generally extending over the buttocks and hamstring covering the back of the thigh from about 8 inches above the knee to the bottom of the waistband and wrapping, for example, about 100 degrees around the back of the leg muscle. The first garment region may comprise material that extends to the knee, to the calf, or to the ankle.

The first garment region in accordance with at least some aspects of this invention will include a second material; the second and third garment regions will include third materials. Each of the first, second, and third materials provide a consistent body skin temperature of 22° C. to about 34° C. when tested on a subject in an environmental chamber at temperatures between −1° C. to 10° C.

The garment for the lower body may include a mesh material such as at the back of the knee joint. In addition, a panel may be present on the outer sides of the lower body to provide color and to slim and elongate the leg.

Instead of separate upper and lower body garments, a single uni-suit or one-piece garment may be produced. Such one-piece garment may have (a) a first garment region generally extending along the front and back of the upper body, but generally excluding at least the top of the forearms and hands; (b) a second garment region generally extending along the forearms, covering an area on top of the forearm, from the elbow to the wrist; (c) a third garment region generally extending along the front and back of the lower body, but generally excluding the quadriceps and buttocks and hamstrings; (d) a fourth garment region generally extending along the quadriceps, covering the front of the thigh from about 2 inches above the knee to the top of the leg (where it bends), and wrapping, for example, 180 degrees around the front thigh muscle; optionally (e) a fifth garment region generally extending over the buttocks and hamstring covering the back of the thigh from about 8 inches above the knee to the bottom of the waistband and wrapping, for example, 100 degrees around the back of the leg muscle; and optionally (f) a sixth garment region generally extending from the sleeve to cover the hands. In one embodiment, the second garment region wraps about 180 degrees around the forearm muscle.

The first garment region in accordance with at least some aspects of this invention will include a first material; the second and third garment regions will include second materials; and the fourth, fifth, and sixth garment regions will include third materials. Each of the materials provide a consistent body skin temperature of 22° C. to about 34° C. when tested on a subject in an environmental chamber at temperatures between −1° C. to 10° C. In addition, the fabrics provide suitable moisture management properties such as effective wicking of moisture away from the body based on the DriFIT standard for wicking.

### 2) Men's Garments

The men's thermal base layer incorporates different materials to keep the body comfortable when running or performing other aerobic activity in cold temperatures between −1° C. to 10° C. (30° to 50° F.).

In general, at least some example aspects of this invention relate to garments also called “articles of apparel” herein designed for men. A garment for a man's upper body may include: (a) a first garment region generally extending along the front and back of the upper body, but generally excluding at least the top of the forearms and hands; (b) a second garment region generally extending along the forearms, covering an area on top of the forearm, from the elbow to the wrist, and optionally (c) a third garment region generally extending from the sleeve to cover the hands. In one embodiment, the second garment region wraps about 180 degrees around the forearm muscle.

The first garment region in accordance with at least some aspects of this invention will include a first material having no appreciable thermal value; the second garment region will include a second material; and the third garment region will include a material. Each of the second and third materials provide a consistent body skin temperature of 22° C. to about 34° C. when tested on a subject in an environmental chamber at temperatures between −1° C. to 10° C. In addition, the fabrics provide suitable moisture management properties such as effective wicking of moisture away from the body based on the DriFIT standard for wicking.

Garment structures in accordance with examples of this invention may take on a variety of forms or structures without departing from this invention. For example, the first garment region may also include part of neck region such as a mock turtleneck. The first garment region may also be prepared from two types of materials that provide the desired body skin temperature. For example, less bulky materials may be used on the side portions of the upper body of the garment underneath the arms to provide efficient arm swing and more flattering seam lines.

Any suitable apparel may be used for the lower body such as apparel made of material having no appreciable thermal value.

Instead of separate upper and lower body garments, a single uni-suit or one-piece garment may be produced. Such one-piece garment may have (a) a first garment region generally extending along the front and back of the upper and lower body, but generally excluding at least the top of the forearms and hands; (b) a second garment region generally extending along the forearms, covering an area on top of the forearm, from the elbow to the wrist; and optionally (c) a third garment region generally extending from the sleeve to cover the hands. In one embodiment, the second garment region wraps about 180 degrees around the forearm muscle.

The first garment region in accordance with at least some aspects of this invention will include a material having no appreciable thermal value; the second garment region will include a second material; and the third garment region will include a third material. Each of the second and third materials provide a consistent body skin temperature of 22° C. to about 34° C. when tested on a subject in an environmental chamber at temperatures between −1° C. to 10° C. In addition, the fabrics provide suitable moisture management properties such as effective wicking of moisture away from the body based on the DriFIT standard for wicking.

Garments may include additional features without departing from this invention. For example, garments in accordance with at least some examples of this invention may include closure systems and/or opening size adjusting systems. Examples of such systems include zippers, buttons, snaps, straps, buckles, hook-type fasteners, hook-and-loop type fasteners, draw string adjusting mechanisms, elastic materials, etc.

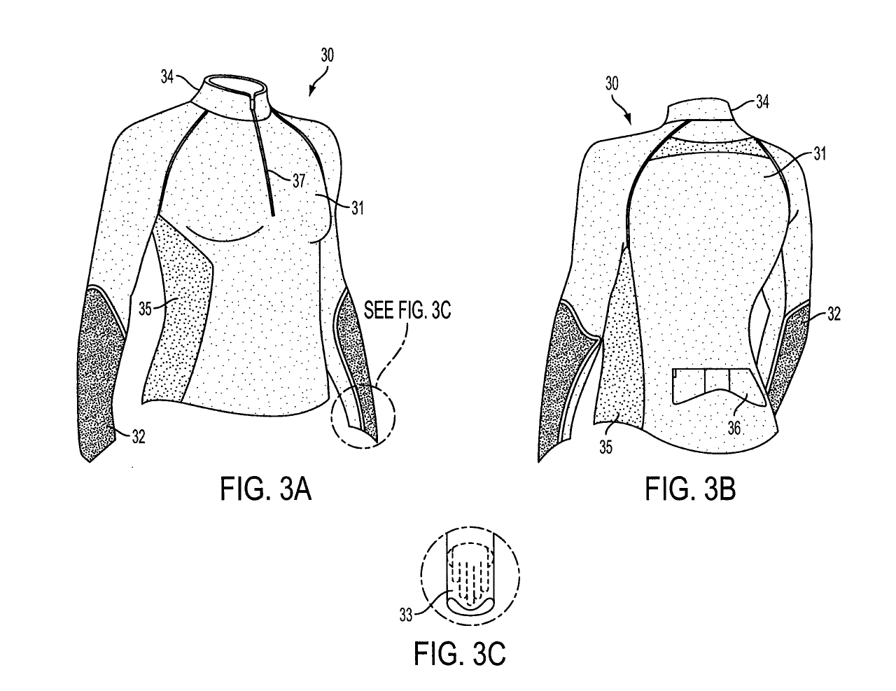

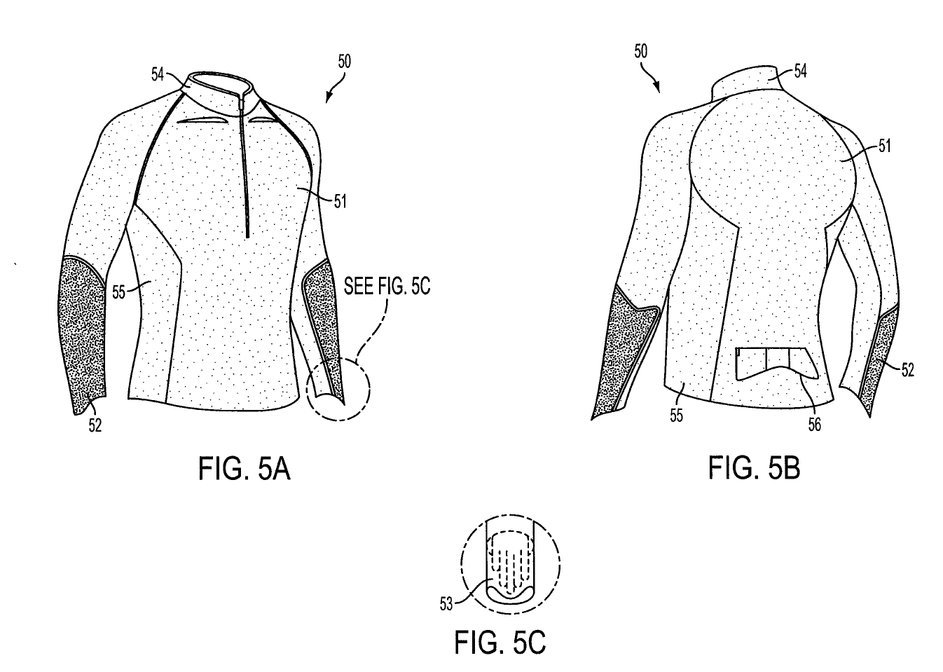

Pockets, see for example pockets 36 and 56 in FIGS. 3 and 5 respectively, may be added to any of the garments to provide for storage of gloves, keys, etc.

A wide variety of overall garment structures may be provided without departing from this invention. Such garments are intended as base layers in temperatures from between −1° C. to 10° C. (30 F to 50 F.) Garment structures in accordance with at least some examples of this invention may cover at least a portion of an upper torso of a human body and may take on a variety of forms, such as shirts, T-shirts, turtlenecks, mock turtlenecks, garment liners, and the like. Additionally, garment structures in accordance with at least some examples of this invention may include garments that, in addition to covering at least a portion of a human upper torso, cover at least a portion of the pelvis and/or lower torso, such as leotards, athletic suits (e.g., of the types used by athletes in winter sports, such as unitards worn in speed skating, skiing, bobsledding, luging, and the like), and the like.

Another type of garment is a sleeve that is pulled on over the arm. The sleeve may be tubular and contain either a glove or a band to prevent the sleeve from moving too far up the arm. For example, a sleeve for a woman may include: (a) a first garment region generally extending along the length of the arm, but excluding at least the top of the forearms and hands; (b) a second garment region generally extending along the forearms, covering an area from the top of the forearm to the wrist and wrapping; and optionally (c) a third garment region generally extending from the sleeve to cover the hands. In one embodiment, the second garment region wraps about 180 degrees around the forearm muscle.

The first garment region in accordance with at least some aspects of this invention will include a first material; the second garment region will include a second material; and the third garment region will include a third material. Each of the first, second, and third materials provide a consistent body skin temperature of 22° C. to about 34° C. when tested on a subject in an environmental chamber at temperatures between −1° C. to 10° C.

A sleeve for a man may include: (a) a first garment region generally extending along the length of the arm, but excluding at least the top of the forearms and hands; (b) a second garment region generally extending along the forearms, covering an area from the top of the forearm to the wrist and wrapping and optionally (c) a third garment region generally extending from the sleeve to cover the hands. In one embodiment, the second garment region wraps about 180 degrees around the forearm muscle.

The first garment region in accordance with at least some aspects of this invention will include a first material; the second garment region will include a second material; and the third garment region will include a third material. Each of the first, second, and third materials provide a consistent body skin temperature of 22° C. to about 34° C. when tested on a subject in an environmental chamber at temperatures between −1° C. to 10° C.

Another garment is a tank top for women prepared from a first material having a first thermal resistive value (B). The tank top is combined with the above-described sleeve to provide a suitable running outfit.

### B. Methods of Making Garments in Accordance with Example Aspects of this Invention

Additional aspects of this invention relate to methods of forming garments, e.g., of the various types described above. Such methods may include, for example: forming an upper body garment structure including: (a) a first garment region generally extending along the front and back of the upper body, but generally excluding at least the top of the forearms and hands; (b) a second garment region generally extending along the forearms, covering an area on top of the forearm, from the elbow to the wrist; and optionally (c) a third garment region generally extending from the sleeve to cover the hands. In one embodiment, the second garment region wraps about 180 degrees around the forearm muscle.

Another method includes forming a garment for a woman's lower body including (a) a first garment region generally extending along the front and back of the lower body, but generally excluding the quadriceps and buttocks and hamstrings; (b) a second garment region generally extending along the quadriceps, covering the front of the thigh from about 2 inches above the knee to the top of the leg (where it bends), and wrapping, for example, about 180 degrees around the front thigh muscle; and optionally (c) a third garment region generally extending over the buttocks and hamstring covering the back of the thigh from about 8 inches above the knee to the bottom of the waistband and wrapping, for example, about 100 degrees around the back of the leg muscle.

Another method includes forming a garment for a man's upper body including: (a) a first garment region generally extending along the front and back of the upper body, but generally excluding at least the top of the forearms and hands; (b) a second garment region generally extending along the forearms, covering an area on top of the forearm, from the elbow to the wrist; and optionally (c) a third garment region generally extending from the sleeve to cover the hands. In one embodiment, the second garment region wraps about 180 degrees around the forearm muscle.

Such garment structures may take on any of the various forms and/or have any of the various characteristics or combinations of characteristics as described above.

Methods according to at least some examples of this invention may include formation of garments as a single piece (e.g., by knitting or other garment forming processes). Alternatively, if desired, garment structures in accordance with at least some examples of this invention may be made from multiple fabric pieces joined together, e.g., in conventional ways as are known and used in the art (such as by sewing or stitching techniques, by adhesives or other fusing techniques, etc.). If desired, the first, second, and third garment regions may be made from separate and independent pieces of fabric material (optionally the same type of fabric material) that are joined to one or more separate pieces of fabric material embodying the fourth garment region (e.g., by sewing or other techniques). Alternatively, if desired, two or more of the various regions may be included as part of a single piece of material. Different methods may be combined to form the garments such as providing a seamless knitted garment with a bonded area of fleece.

Specific examples of the invention are described in more detail below. The reader should understand that these specific examples are set forth merely to illustrate examples of the invention, and they should not be construed as limiting the invention.

### II. SPECIFIC EXAMPLES OF THE INVENTION

FIGS. 3A-3C, 4A-4B, 5A-5C, 6A-6B, 7A-7B, 8A-8B, and 9 in this application illustrate various examples of garment structures in accordance with this invention. When the same reference number appears in more than one drawing, that reference number is used consistently in this specification and the drawings to refer to the same or similar parts or elements throughout.

FIGS. 3A and 3B illustrate the front and back, respectively, of a garment structure 30 in accordance with one example of this invention. This garment structure is designed for an upper body of a woman. As shown, this garment structure 30 has one garment region 31 that makes up a majority of the overall garment structure 30 (e.g., the majority of the garment's interior surface, exterior surface, and/or volume). In this illustrated example, garment region 31 forms most of the garment front, back and upper arms, and a portion of the lower arms. Garment region 31 may be made from one or multiple pieces without departing from the invention.

The garment structure 30 includes other discrete regions as well. Compared to region 31, at least some of these additional regions will be regions having different properties such as different thermal insulative properties, thermal resistance, air permeability, stretch, and the like as in order to achieve a desired consistent body skin temperature of about 22° C. to about 34° C. As shown in FIG. 3A, one of these regions, region 32, extends along the forearms of the garment structure 31, covering at least the area from the top of the forearm to the wrist and 180 degrees around the forearm muscle. Another of these regions, region 33 in this example garment structure 30, extends from the end of the sleeve at the wrist to cover the hands as shown in FIG. 3C. If desired, any or all of regions 32 and 33 may be made from multiple pieces of fabric without departing from this invention.

Thermal research on a woman's body has demonstrated that the body releases heat at a woman's upper body, even more heat at a woman's forearm, and even more heat at a woman's hands. Therefore, providing tailored properties in these areas of a garment can help keep the garment wearer warm by holding this released heat close to the body.

Providing a garment structure with discrete zones of materials having tailored properties at one or more of these targeted zones or locations of the body allows one to produce a relatively lightweight and less bulky base layer garment that still performs well in keeping the wearer warm. Such lightweight and reduced bulk garments can be particularly useful for athletes and others where free movement and flexibility are important. The lightweight and low bulk garments also are advantageous for relatively compact packing purposes (e.g., reduced product volume from a manufacturer's or wholesaler's perspective (e.g., for product shipping and storage), from a retailer's perspective (e.g., for display or storage), and/or from an end user's perspective (when packing for a trip, storing at home, etc.).

Differences in thermal properties of the garment may be achieved in the various different regions 31, 32, and 33 of a garment structure 30 in a variety of different manners without departing from this invention. For example, if desired, the various regions of the garment structure 30 may be made from separate and distinct pieces of fabric material that have different thermal properties, and these various pieces of material may be sewn together or otherwise engaged together (e.g., in manners that are known and conventionally used in the garment production arts) so as to provide the desired materials at the desired locations (regions 31, 32, and 33) in the garment structure 30. As another example, if desired, the regions 31, 32, and 33 of the garment structure 30 having different thermal properties may be provided by using different types of fill materials, by providing a fill material and/or by providing more fill material in regions 32 and 33 as compared with region(s) 31. Any desired thermal materials may be used without departing from this invention, such as down materials, insulative textile or fabric fill materials, etc. As yet additional examples, if desired, regions 31, 32, and/or 33 may be coated, laminated, impregnated, doped, and/or otherwise treated (and/or region 33 treated as compared to regions 31 and/or 32) to thereby alter their thermal properties.

Any desired fabric materials may be used for garments structures in accordance with examples of this invention. As some more specific examples, the garments (including all of the noted regions 31-33) may be made from one or more “thermal materials,” e.g., materials that help retain body heat or that are resistive to heat transfer. The thermal materials may be natural or synthetic fabrics (e.g., cottons, polyesters, or other polymeric materials, etc.). As some even more specific examples, the thermal materials for any and/or all regions 31-33 of the overall garment structure 108 may be polyester fleece or other polyester thermal materials, such as the THERMA-FIT® and SPHERE® Thermal fabric materials commercially available in various garment products from NIKE, Inc. of Beaverton, Oreg.

Any desired degree of difference in thermal insulative or thermal resistive properties may be provided in the various regions without departing from this invention (e.g., in region(s) 31 as compared to regions 32 and/or 33). Compared to region 31, at least some of these additional regions will be regions having different properties such as different thermal insulative properties, thermal resistance, air permeability, stretch, and the like as in order to achieve a desired consistent body skin temperature of about 22° C. to about 34° C.

In some aspects, the thermal resistive value of fabric used in the second region is at least 5% or 10% higher than the thermal resistive value of fabric used in the first region and the thermal resistive value of fabric used in the third region is at least 5% or 10% higher than the thermal resistive value of fabric used in the second region.

The various regions 31, 32, and/or 33 in the garment structure 30 also may take on a wide variety of different sizes and/or shapes without departing from this invention. In the illustrated example, first garment region 31 extends continuously from proximate to the neck area 34 of the garment structure 30 to proximate to the waist area. Neck area 34 is made with material having the same RCT value as region 31. Garment region 31 may also be prepared from two types of materials having the same properties such as thermal insulative properties, air permeability, stretch, and the like. For example, less bulky materials may be used on the side regions 35 of the upper body of the garment underneath the arms to provide efficient arm swing and more flattering seam lines.

The side regions 35 in this example structure 30 wrap around the garment 30 in a direction from the front to back and extend continuously between proximate to the underarm area of the garment structure 30 to proximate to the waist area. Side regions may vary depending on the particular sport the garment is intended for.

FIG. 3A further illustrates that garment structures 30 in accordance with examples of this invention further may include a closure system 37. Any type of closure system may be included, at any desired location(s) in the garment structure 30, without departing from this invention. In this illustrated example garment structure 30, the closure system 37 is a conventional zipper type closure system. Zippers may also allow for heat dissipation. Other potential closure systems that may be included in garment structures without departing from this invention include, for example: buttons, snaps, hook-type fasteners, hook-and-loop type fasteners, draw string and/or tie type fasteners, straps, buckles, etc.

As mentioned above, the various regions of a garment structure may have a variety of shapes, sizes, and/or arrangements without departing from this invention.

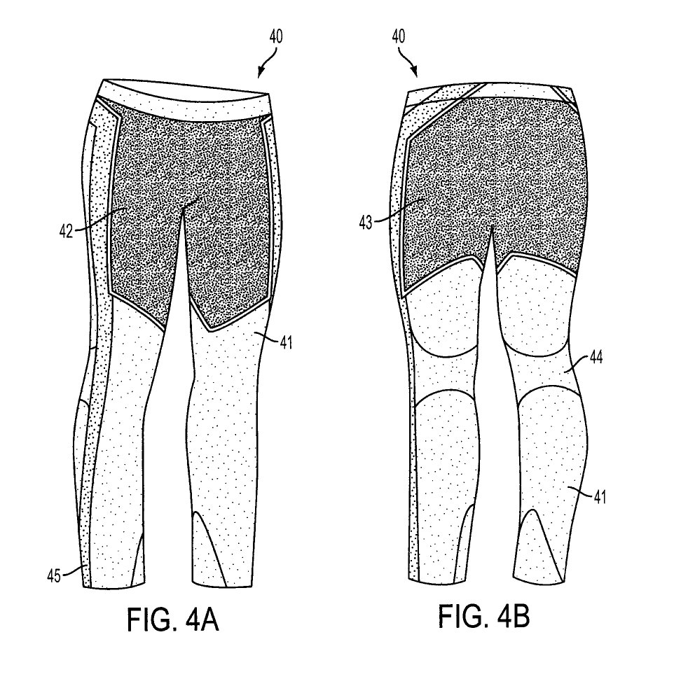

FIGS. 4A and 4B illustrate an example of garment structure for a lower body of a woman in accordance with this invention. The garment 40 includes a garment region 41 extending along the front and back of the lower body, but excluding the quadriceps, buttocks, and hamstrings. Garment region 42 extends along the quadriceps, covering the front of the thigh from about 2 inches above the knee to the top of the leg (where it bends), and wrapping 180 degrees around the front thigh muscle. Third garment region 33 extends over the buttocks and hamstring covering the back of the thigh from about 8 inches above the knee to the bottom of the waistband and wrapping 100 degrees around the back of the leg muscle.

In some aspects, the thermal resistive values of fabrics used in the second and third regions are at least 5% or 10% higher than the thermal resistive value of fabric used in the first region.

FIGS. 5A and 5B illustrate the back and front, respectively, of a garment structure 50 in accordance with another example of this invention. This garment structure is designed for an upper body of a man. As shown, this garment structure 50 has one garment region 51 that makes up a majority of the overall garment structure 50 (e.g., the majority of the garment's interior surface, exterior surface, and/or volume). In this illustrated example, garment region 51 forms most of the garment front, back and upper arms, and a portion of the lower arms. Garment region 51 may be made from one or multiple pieces without departing from the invention. Garment region 51 generally has no or very low thermal properties.

The garment structure 50 includes other discrete regions as well. At least some of these additional regions will be regions having increased thermal insulative properties or increased thermal resistance as compared to region 51. As shown in FIG. 5A, one of these regions, region 52, extends along the forearms of the garment structure 51, covering at least the area from the top of the forearm to the wrist and 180 degrees around the forearm muscle. Another of these regions, region 53 in this example garment structure 50, extends from the end of the sleeve at the wrist to cover the hands as shown in FIG. 5C. Region 53 in this example structure 50 has different thermal properties as compared to region 32. If desired, any or all of regions 52 and 53 may be made from multiple pieces of fabric without departing from this invention.

Thermal research on a man's body has demonstrated that the upper body stays comfortable, but does not maintain heat as well at a man's forearm, and more heat at a man's hands. Therefore, providing adequate thermal insulation in areas 52 and 53 of a garment can help keep the garment wearer warm by holding this released heat close to the body.

Similar to the woman's garment discussed above, differences in thermal insulative properties or thermal resistance may be achieved in the various different regions 52 and 53 of a garment structure 50 in a variety of different manners without departing from this invention. For example, if desired, the various regions of the garment structure 50 may be made from separate and distinct pieces of fabric material that have different thermal properties, and these various pieces of material may be sewn together or otherwise engaged together (e.g., in manners that are known and conventionally used in the garment production arts) so as to provide the desired thermal properties at the desired locations (regions 52 and 53) in the garment structure 50. As another example, if desired, the regions 52 and 53 of the garment structure 50 having higher thermal insulative or thermal resistance properties may be provided by using different types of fill materials, by providing a fill material (as compared to an absence of fill material in region 51). Any desired thermally insulative or thermally resistive fill materials may be used without departing from this invention, such as down materials, insulative textile or fabric fill materials, etc. As yet additional examples, if desired, regions 52 and/or 53 may be coated, laminated, impregnated, doped, and/or otherwise treated as compared to region 51 (and/or region 53 treated as compared to regions 51 and 52) to thereby alter their thermal insulative and/or thermal resistive properties.

Any desired fabric materials may be used for garments structures in accordance with examples of this invention. As some more specific examples, the garments (including all of the noted regions 52-53) may be made from one or more “thermal materials,” e.g., materials that help retain body heat or that are resistive to heat transfer. The thermal materials may be natural or synthetic fabrics (e.g., cottons, polyesters, or other polymeric materials, etc.). As some even more specific examples, the thermal materials for any and/or all regions 52-53 of the overall garment structure 108 may be polyester fleece or other polyester thermal materials, such as the THERMA-FIT® and SPHERE® Thermal fabric materials commercially available in various garment products from NIKE, Inc. of Beaverton, Oreg.

Any desired degree of difference in thermal properties may be provided in the various regions without departing from this invention (e.g., in region(s) 51 as compared to regions 52 and/or 53).

In some aspects, the thermal resistive value of fabric used in the second region is at least 5% or 10% higher than the thermal resistive value of fabric used in the first region and the thermal resistive value of fabric used in the third region is at least 5% or 10% higher than the thermal resistive value of fabric used in the second region.

The various regions 51, 52, and/or 53 in the garment structure 50 also may take on a wide variety of different sizes and/or shapes without departing from this invention. In the illustrated example, first garment region 51 extends continuously from proximate to the neck area 54 of the garment structure 50 to proximate to the waist area. Neck area 54 is made with material having no or little thermal properties as region 51. Garment region 51 may also be prepared from two types of materials having no or little thermal properties. For example, less bulky materials may be used on the side regions 55 of the upper body of the garment underneath the arms to provide efficient arm swing and more flattering seam lines.

The side regions 55 in this example structure 50 wrap around the garment 50 in a direction from the front to back and extend continuously between proximate to the underarm area of the garment structure 50 to proximate to the waist area. Side regions may vary depending on the particular sport the garment is intended for.

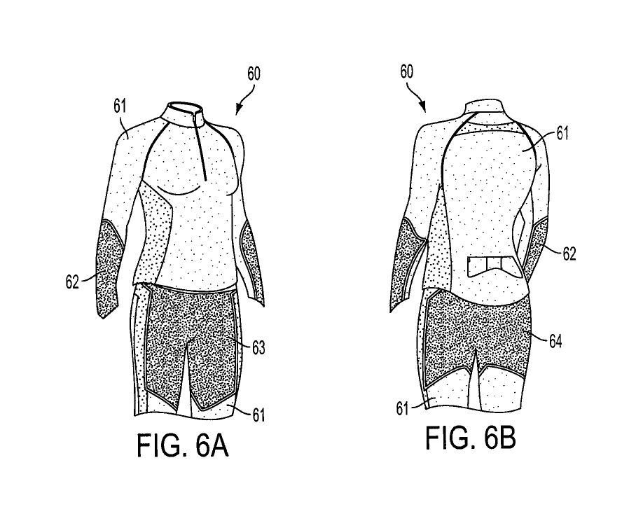

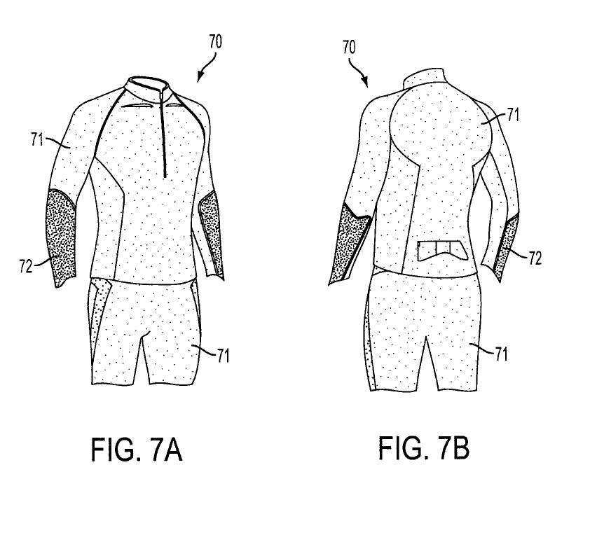

Further examples illustrate uni-suits or one piece suits, such as worn by bicyclists or triathlon athletes. FIGS. 6A and 6B illustrate such a suit for women and FIGS. 7A and 7B illustrate such a suit for a man.

FIGS. 6A and 6B illustrate the back and front, respectively, of a garment structure 60 in accordance with one example of this invention. This garment structure is designed as a one-piece or uni-suit a woman. The garment 60 has features similar to those described for the garment for the upper body 30 and the garment for the lower body 40. As shown, this garment structure 60 has one garment region 61 that makes up a majority of the overall body garment structure 60 (e.g., the majority of the garment's interior surface, exterior surface, and/or volume). In this illustrated example, garment region 61 forms most of the garment front and back of the upper body, upper arms, a portion of the lower arms, and the front and back of the lower body, but excluding the quadriceps, buttocks, and hamstrings. Garment region 61 may be made from one or multiple pieces without departing from the invention. The garment illustrated has a length to above the knees. It should be understood that the length may be any suitable length such as to the knees, to the calves, or to the ankles.

The garment structure 60 includes other discrete regions as well. At least some of these additional regions will be regions having increased thermal properties as compared to region 61. As shown in FIG. 6A, one of these regions, region 62, extends along the forearms of the garment structure 61, covering at least the area from the top of the forearm to the wrist and 180 degrees around the forearm muscle. Region 62 has different properties as compared to region 61. Garment region 63 extends along the quadriceps, covering the front of the thigh from about 2 inches above the knee to the top of the leg (where it bends), and wrapping 180 degrees around the front thigh muscle. Third garment region 64 extends over the buttocks and hamstring covering the back of the thigh from about 8 inches above the knee to the bottom of the waistband and wrapping 100 degrees around the back of the leg muscle.

If desired, any or all of regions may be made from multiple pieces of fabric without departing from this invention.

Differences in thermal insulative properties or thermal resistance may be achieved in the various different regions 61, 62, 63 and 64 of a garment structure 60 in a variety of different manners without departing from this invention as discussed for Garments 30 and 40 and incorporated herein by reference.

FIGS. 7A and 7B illustrate the back and front, respectively, of a garment structure 70 in accordance with one example of this invention. This garment structure is designed as a one-piece or uni-suit for a man. The garment 70 has features similar to those described for the garment for the upper body 50. As shown, this garment structure 70 has one garment region 71 that makes up a majority of the overall body garment structure 70 (e.g., the majority of the garment's interior surface, exterior surface, and/or volume). In this illustrated example, garment region 71 forms most of the garment front and back of the upper body, upper arms, a portion of the lower arms, and the lower body. The garment illustrated has a length to above the knees. It should be understood that the length may be any suitable length such as to the knees, to the calves, or to the ankles.

The garment structure 70 includes at least one other discrete region as well. At least some of these additional regions will be regions having different thermal properties as compared to region 71. As shown in FIG. 7A, region 72, extends along the forearms of the garment structure 70, covering at least the area from the top of the forearm to the wrist and 180 degrees around the forearm muscle. Region 72 in this example structure 70 has different thermal properties compared to region 71. If desired, any or all of regions may be made from multiple pieces of fabric without departing from this invention.

The thermal properties may be achieved in the region 72 of a garment structure 70 in a variety of different manners without departing from this invention as discussed for Garments 50 incorporated herein by reference.

In both the women's and men's one piece design, the sleeves may be extended as illustrated in FIG. 3A, item 33, and FIG. 5A, item 53 respectfully, to provide thermal covering for the hands.

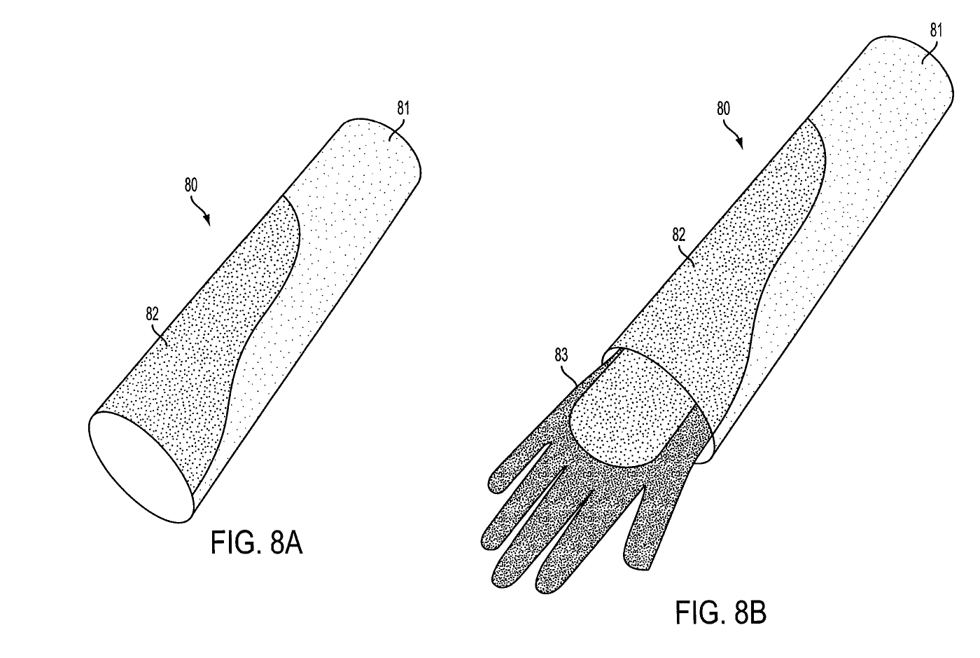

Another aspect of the invention relates to a removable sleeve that provides thermal insulation to the forearms. See FIGS. 8A and 8B. Such sleeves are used by cyclists, for example, to warm up, but can be removed and discarded during the ride without stopping. The sleeve may be used for men or women.

The sleeve 80 may be tubular and contain either a glove or a band to prevent the sleeve from moving too far up the arm. For example, a sleeve 80 for a woman or a man may include: (a) a first garment region 81 extending along the length of the arm, but excluding the forearms and hands; (b) a second garment region 82 extending along the forearms, covering at least the area from the top of the forearm to the wrist and 180 degrees around the forearm muscle; and optionally (c) a third garment region 83 extending from the sleeve to cover the hands (See FIG. 8b).

For a woman, the first garment region in accordance with at least some aspects of this invention will include a first material; the second garment region will include a second material; and the third garment region will include a third material. Each of the first, second, and third materials provide a consistent body skin temperature of 22° C. to about 34° C. when tested on a subject in an environmental chamber at temperatures between −1° C. to 10° C.

For a man, the first garment region in accordance with at least some aspects of this invention will include a first material having no little or no thermal value; the second garment region will include a second material; and the third garment region will include a third material. Each of the second and third materials provide a consistent body skin temperature of 22° C. to about 34° C. when tested on a subject in an environmental chamber at temperatures between −1° C. to 10° C.

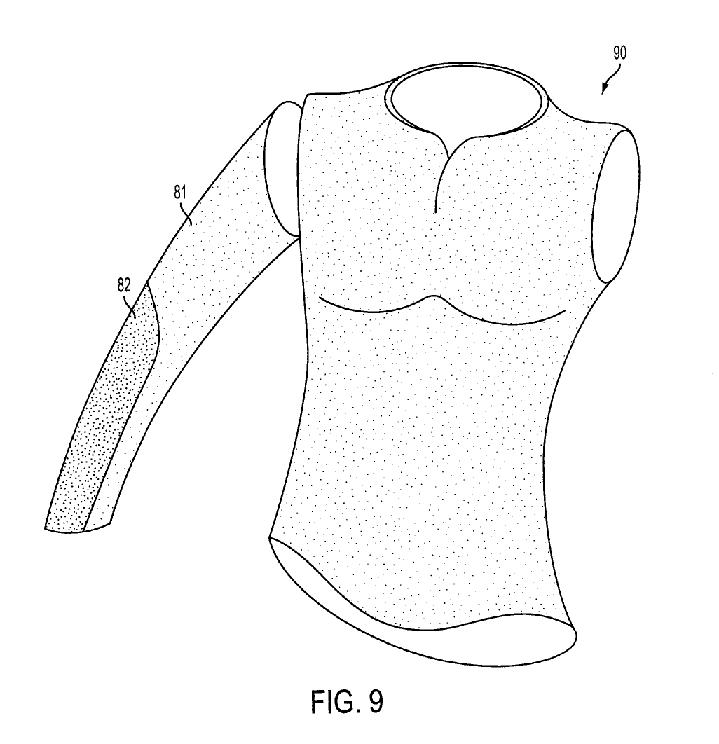

As shown in FIG. 9, another garment is a tank top 90 for women prepared from a first material. The material provides a consistent body skin temperature of 22° C. to about 34° C. when tested on a subject in an environmental chamber at temperatures between −1° C. to 10° C. The tank top is combined with the above-described removable sleeve 80 to provide a suitable running outfit.

A wide variety of other variations in the sizes, structures, and/or arrangements of the various regions of a garment structure are possible without departing from this invention. For example, in the various garment structures 30, 40, 50, 60, and 70 described above, the regions were continuous. This is not a requirement.

Garments in accordance with other aspects of this invention designed for the upper body of a woman or man may include: a first garment region generally extending along the front and back of the upper body from proximate to a hip area of the garment to proximate to a neck area of the garment but generally excluding the forearms and hands; and a second garment region generally extending along the forearms, covering at least the area from the top of the forearm, from elbow to the wrist, and generally extending over the hands; wherein the first garment region includes a first material and the second garment region includes a second material, wherein each of the first and second materials provide a consistent body skin temperature of about 22° C. to about 34° C. (about 71° F. to about 93° F.) when tested on a subject in an environmental chamber at temperatures between −1° C. to 10° C. (30° F. and 50° F.). Thus, in FIG. 5a and FIG. 5c, items 51, 54, 55, and 56 would be made of a first material and items 52 and 53 would be made of a second material as described above.

Garments in accordance with other aspects of this invention designed for the lower body of a woman or man may include a material that provides a consistent body skin temperature of 22° C. to about 34° C. when tested on a subject in an environmental chamber at temperatures between −1° C. to 10° C. Thus, in FIGS. 4a and 4b, the entire garment would be made of a first material.

Garments in accordance with examples of this invention may be produced in any desired manner without departing from this invention, including, at least in part, through the use of conventional production steps and/or convention production equipment as are known and used in the garment formation art. For example, if desired, one or more separate pieces of material may be provided for each of the various regions (e.g., regions 31-35), and the various pieces of material may be engaged with one another so as to locate the various regions in their desired positions as described above. Sewing, stitching, adherents, fusing techniques, or the like may be used to engage the various pieces of material together. Additionally, the closure system(s) and/or size adjusting system(s) (e.g., buttons, snaps, straps, buckles, hook-type fasteners, hook-and-loop type fasteners, draw string and/or tie type fasteners, elastic materials, etc.), if any, may be included in the garment structures in any desired manners without departing from this invention, including in manners that are conventionally known and used in the art. As additional examples, commercial garment knitting and/or weaving machines may be programmed to produce the desired garment structure including the desired regions of different thermal insulative or resistive properties (e.g., by selecting different yarns, stitching patterns, weaving patterns, texturing, or the like at the various locations of the desired regions).

Of course, a wide variety of variations in the fabrics, garments, and/or their production processes are possible without departing from this invention. For example, if desired, one or more of the various high thermally resistive regions may be omitted from a specific garment structure in accordance with at least some examples of this invention. Moreover, the various different steps in the production processes may be changed, changed in order, additional steps may be added, and/or the described steps may be eliminated and/or replaced with other steps or procedures without departing from this invention.

### III. CONCLUSION

Aspects of this invention may be used in conjunction with systems and methods like those described in commonly owned and co-pending U.S. patent application Ser. No. 11/059,357, filed Feb. 17, 2005 in the name of Edward L. Harber and entitled “Articles of Apparel Utilizing Targeted Venting or Heat Retention Zones that may be Defined Based on Thermal Profiles” and U.S. patent application Ser. No. 11/424,991, filed Jun. 19, 2006 in the name of Edward L. Harber and entitled “Fabrics and Articles of Apparel Including Dimensionalized Mesh and Other Fabrics.” These co-pending U.S. Patent Applications are entirely incorporated herein by reference.

Various examples of the present invention have been described above, and it will be understood by those of ordinary skill that the present invention includes within its scope all combinations and subcombinations of these examples. Additionally, those skilled in the art will recognize that the above examples simply exemplify the invention. Various changes and modifications may be made without departing from the spirit and scope of the invention, as defined in the appended claims.

What is claimed is:

1. A garment for covering at least a portion of an upper female human torso, comprising:
a first garment region extending along the front and back of the upper body from proximate to the hip area of the garment to proximate to a neck area of the garment but excluding the forearms and hands;
a second garment region extending along the forearms, covering at least the area from the top of the forearm to the wrist and 180 degrees around the forearm muscle;
wherein the first garment region includes a first material having a first thermal resistive value, wherein the second garment region includes a second material having a second thermal resistive value higher than the first thermal resistive value.

2. A garment according to claim 1, further comprising a third garment region extending from the sleeve to cover the hands.

3. A garment according to claim 2, wherein the third garment region includes a third material having a third thermal resistive value higher than the second thermal resistive value

4. A garment according to claim 1, wherein the second thermal resistive value is at least 5% higher than the first thermal resistive value.

5. A garment according to claim 1, wherein the second thermal resistive value is at least 10% higher than the first thermal resistive value.

6. A garment according to claim 2, wherein the third thermal resistive value is at least 5% higher than the second thermal resistive value.

7. A garment according to claim 2, wherein the third thermal resistive value is at least 10% higher than the second thermal resistive value.

8. A garment according to claim 1, wherein each of the first and second materials provide a consistent body skin temperature of 22° C. to about 34° C. when tested on a subject in an environmental chamber at temperatures between −1° C. to 10° C.

9. A garment according to claim 3, wherein each of the first, second, and third materials provide a consistent body skin temperature of 22° C. to about 34° C. when tested on a subject in an environmental chamber at temperatures between −1° C. to 10° C.

10. A garment according to claim 1, wherein the first material meets an RCT value of about 0.013 to about 0.020.

11. A garment according to claim 1, wherein the second material meets an RCT value of about 0.029 to about 0.040.

12. A garment according to claim 3, wherein the third material meets an RCT value of about 0.029 to about 0.040.

13. A garment according to claim 1, further comprising:
a garment closure system engaged with at least one garment region.

14. A garment for covering at least a portion of a lower female torso comprising;
a first garment region extending along the front and back of the lower body, excluding the quadriceps and buttocks and hamstrings; and
a second garment region extending along the quadriceps, covering the front of the thigh from about 2 inches above the knee to the top of the leg, and wrapping about 180 degrees around the front thigh muscle.
wherein the first garment region includes a first material having a first thermal resistive value, wherein the second garment region includes a second material having a second thermal resistive value higher than the first thermal resistive value.

15. A garment of claim 14 further comprising:
a third garment region extending over the buttocks and hamstring covering the back of the thigh;
wherein the third garment region includes a third material having a third thermal resistive value higher than the first thermal resistive value.

16. A garment of claim 14 wherein the first region comprises first material that extends to the knee, to the calf, or to the ankle.

17. A garment of claim 14 wherein the third region comprises third material that extends from about 8 inches above the knee to the bottom of the waistband and wraps 100 degrees around the back of the leg muscle.

18. A garment according to claim 14, wherein the first material meets an RCT value of about 0.013 to about 0.020

19. A garment according to claim 14, wherein the second material meets an RCT value of about 0.029 to about 0.040.

20. A garment according to claim 15, wherein the third material meets an RCT value of about 0.029 to about 0.040.

21. A garment for covering at least a portion of an upper male human torso, comprising:
a first garment region extending along the front and back of the upper body from proximate to a waist area of the garment to proximate to a neck area of the garment but excluding the forearms and hands;
a second garment region extending along the forearms, covering at least the area from the top of the forearm to the wrist and 180 degrees around the forearm muscle;
wherein the first garment region includes a material having a first material having a first thermal resistive value of about zero, wherein the second garment region includes a second material having a second thermal resistive value.

22. A garment according to claim 21, further comprising a third garment region extending from the sleeve to cover the hands.

23. A garment according to claim 22, wherein the third garment region includes a third material having a third thermal resistive value higher than the second thermal resistive value

24. A garment according to claim 23, wherein the second thermal resistive value is at least 5% higher than the first thermal resistive value.

25. A garment according to claim 24, wherein the second thermal resistive value is at least 10% higher than the first thermal resistive value.

26. A garment according to claim 21, wherein each of the first and second materials provide a consistent body skin temperature of 22° C. to about 34° C. when tested on a subject in an environmental chamber at temperatures between −1° C. to 10° C.

27. A garment according to claim 23, wherein each of the first, second, and third materials provide a consistent body skin temperature of 22° C. to about 34° C. when tested on a subject in an environmental chamber at temperatures between −1° C. to 10° C.

28. A garment according to claim 21, wherein the second material meets an RCT value of about 0.013 to about 0.020.

29. A garment according to claim 23, wherein the third material meets an RCT value of about 0.029 to about 0.040.

30. A garment according to claim 21, further comprising:
a garment closure system engaged with at least one garment region.

31. A garment for covering at least a portion of an upper human torso, comprising:
a first garment region extending along the front and back of the upper body from proximate to the hip area of the garment to proximate to a neck area of the garment but excluding the forearms and hands;
a second garment region extending along the forearms, covering at least the area from the top of the forearm to the wrist and 180 degrees around the forearm muscle, and hands;
wherein the first garment region includes a first material having a first thermal resistive value, wherein the second garment region includes a second material having a second thermal resistive value higher than the first thermal resistive value.

33. A method of forming a garment for covering at least a portion of an upper torso of a woman, comprising:
forming a garment structure including: a first garment region extending along the front and back of the upper body from proximate to a waist area of the garment to proximate to a neck area of the garment but excluding the forearms and hands;
a second garment region extending along the forearms, covering at least the area from the top of the forearm, from the elbow to the wrist and 180 degrees around the forearm muscle;
wherein the first garment region includes a first material having a first thermal resistive value, wherein the second garment region includes a second material having a second thermal resistive value higher than the first thermal resistive value.

34. A method of forming a garment for covering at least a portion of an upper torso of a man, comprising:
a first garment region extending along the front and back of the upper body from proximate to a waist area of the garment to proximate to a neck area of the garment but excluding the forearms and hands;
a second garment region extending along the forearms, covering at least the area from the top of the forearm, from the elbow to the wrist and 180 degrees around the forearm muscle;
wherein the first garment region includes a first material having a first thermal resistive value of about zero, wherein the second garment region includes a second material having a second thermal resistive value.
